(19) United States
(12) Patent Application Publication
(10) Pub. No.: US 2005/0157735 A1
(43) Pub. Date: Jul. 21, 2005

(54) Network with packet traffic scheduling in response to quality of service and index dispersion of counts

(75) Inventors: Chao Kan, Frisco, TX (US); Frederick Skoog, Colleyville, TX (US)

Correspondence Address: ALCATEL USA;INTELLECTUAL PROPERTY DEPARTMENT, 3400 W. PLANO PARKWAY, MS LEGL2, PLANO, TX, 75075, US

(73) Assignee: Alcatel, Paris (FR)

(21) Appl. No.: 10/697,781

(22) Filed: Oct. 30, 2003

(51) Int. Cl. H04L 12/56

(52) U.S. Cl. 370/412; 370/230; 370/235

(57) ABSTRACT

A network system (10), comprising a plurality of nodes (ERₓ, CRₓ). Each node in the plurality of nodes is coupled to communicate with at least one other node in the plurality of nodes. Each node of the plurality of nodes comprises a plurality of queues (32ₓ) and is operable to perform the steps of receiving a plurality of packets and, for each received packet in the plurality of packets, coupling the received packet into a selected queue in the plurality of queues, wherein a respective selected queue is selected in response to the respective received packet satisfying one or more criteria. Each node of the plurality of nodes is also operable to perform the step of assigning a weight (Wₓ) to each respective queues in the plurality of queues. Each weight assigned to a respective queue in the plurality of queues is responsive to quality requirements for each packet in the respective queue and to a ratio of packet arrival variance in the respective queue and a mean of packets arriving to be stored in the respective queue during a time interval for minimizing the overall network traffic burstiness.

### CROSS-REFERENCES TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

The present embodiments relate to computer networks and are more particularly directed to a network with routers or switches configured to schedule traffic according to a dynamic fair mechanism in response to quality of service and an index dispersion of counts.

As the number of users, traffic volume, and packet speed continue to grow on the global Internet and other networks, an essential need has arisen to provide efficient scheduling mechanisms for packet switched networks. More recently, scheduling has been implicated as needing to consider that the Internet is also evolving towards an advanced architecture that seeks to guarantee the quality of service (“QoS”) for real-time applications. QoS dictates the treatment given to packets as they are routed in a network. One type of QoS framework seeks to provide hard specific network performance guarantees to applications such as bandwidth/delay reservations for an imminent or future data flow. Such QoS is usually characterized in terms of ability to guarantee to an application-specified peak and average bandwidth, delay, jitter, and packet loss. Another type is to use Class-of-Service (“CoS”) such as Differentiated Services (“Diff-Serv”) to represent the less ambitious approach of giving preferential treatment to certain kinds of packets, but without making any performance guarantees.

Given the preceding, scheduling mechanisms for packet traffic in switches and routers play a sometimes critical role in providing the QoS guarantees required by many applications such as video-on-demand and multimedia video or teleconferencing. Typical prior art implementations in a router include a number of queues, where packets in each queue belong to a predefined “flow,” meaning those packets share one or more predefined attributes. With this structure, classical fair-share scheduling assigns a share of link bandwidth to each queue according to a defined weight for each queue in a fair manner for better QoS implementation. The scheduler chooses in what order service requests can access resources, dictates how to multiplex packets from different connections, and decides which packets to transmit. Various goals are often presented in connection with the scheduling philosophy. For example, a good service discipline should allow the network to treat users differently in accordance with their QoS requirements. As another example, preferably the service discipline can protect packets of well-behaving guaranteed source clients from unconstrained best effort traffic, that is, these sources are given certain bandwidth, yet this flexibility should not compromise the fairness of the scheme to such an extent such that a few classes of users should not be able to degrade service in other classes to the extent that performance guarantees are violated. To allocate bandwidth in a way that QoS of all active flows are satisfied as much as possible, the excess bandwidth of a flow or a class of flows is not only reused by that flow or class, but in some instances it is allocated to other flows or classes as well. The fair-share allocation intends that the flows having little QoS requirements such as Best-Effort traffic can capture the least bandwidth. The fairness for the excess bandwidth allocation can be weighted so that the flows in the higher classes can obtain more bandwidth.

In general, the prior art scheduling mechanisms fall into two categories, namely, static weight allocation and dynamic weight allocation. Many static schedulers in fast packet routers and switches attempt to provide fair service across a range of traffic classes by employing derivatives of the Generalized Processor Sharing (“GPS”) discipline, in which each of the sessions sharing the link has a first-in first-out (“FIFO”) queue. The scheduler assigns a predetermined weight to each different FIFO queue so that the packets stored in the respective queue are treated according to their assigned weight. However, GPS is limited in that it does not transmit packets as entities, and only one session can receive service at a time and an entire packet must be served before another packet can be served. A typical dynamic scheduling mechanism is the dynamic Weighted Fair Queuing, in which agents in the routers dynamically reconfigure the weights of their associated services. In this scheme, the weights are modified to reflect the changing QoS requirements of a number of packet streams as their queue sizes change over time based on the pre-defined committed information rates.

While the preceding approaches have merit in some applications, they also include various drawbacks. For example, ideally the traffic scheduler should be influenced by a number of parameters including packet delay and buffer occupancy. However, various static weight allocation mechanisms generally consider little of real-time traffic measurements and QoS information. Instead, they often determine the schedule by sorting the timestamps of packets contending for the link. The exception of brief dynamic behavior in Weighted Fair Queuing itself also focuses around the packet being serviced at that instant in time, and it does not consider the system as a whole and the effect it has on the other sessions later. Further, current dynamic weight allocation mechanisms are not optimized as most of them depend solely on the number of active flows. Although a few of them do consider the QoS information, they merely allocate the excess bandwidth according to the number of flows in a specific class of service or the pre-defined committed information rates.

In view of the above, there arises a need to address the drawbacks of the prior art, as is accomplished by the preferred embodiments described below.

### BRIEF SUMMARY OF THE INVENTION

In the preferred embodiment, there is a network system, comprising a plurality of nodes. Each node in the plurality of nodes is coupled to communicate with at least one other node in the plurality of nodes. Each node of the plurality of nodes comprises a plurality of queues and is operable to perform the steps of receiving a plurality of packets and, for each received packet in the plurality of packets, coupling the received packet into a selected queue in the plurality of queues, wherein a respective selected queue is selected in response to the respective received packet satisfying one or more criteria. Each node of the plurality of nodes is also operable to perform the step of assigning a weight to each respective queues in the plurality of queues. Each weight assigned to a respective queue in the plurality of queues is responsive to quality requirements for each packet in the respective queue and to a ratio of packet arrival variance in the respective queue and a mean of packets arriving to be stored in the respective queue during a time interval.

Other aspects are also described and claimed.

### BRIEF DESCRIPTION OF THE SEVERAL VIEWS OF THE DRAWING

FIG. 1 illustrates a block diagram of a network system 10 into which the preferred embodiments may be implemented.

FIG. 2 illustrates a functional block diagram of preferred aspects of a network packet transfer device of FIG. 1.

### DETAILED DESCRIPTION OF THE INVENTION

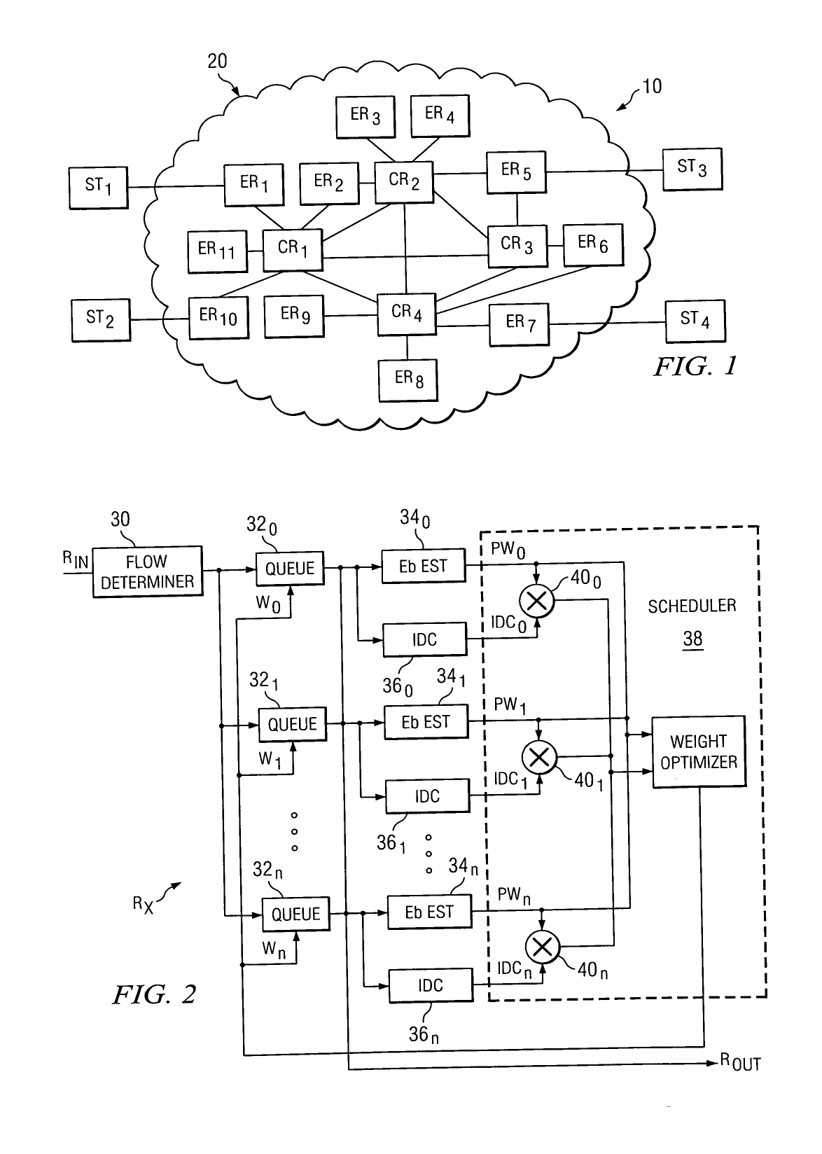

FIG. 1 illustrates a block diagram of a system 10 into which the preferred embodiments may be implemented. By way of introduction, FIG. 1 is a functional and logical illustration, that is, it is intended to illustrate the functional operations of a router Rₓ as well as some of its logical connections, where in certain locations as detailed below actual physical connections are not expressly as shown so as to avoid complicating the data link. Looking then to system 10 in general, it includes a number of stations ST₁ through ST₄, each coupled to a network 20 via a packet transfer device. The term packet transfer device is used in this document in a general sense to refer to any device, typically implemented as a combination of hardware, software, and firmware, that operates to receive a network packet and to place it in one of a number of queues (or buffers), where thereafter the packet transfer device schedules services for the queued packets so as to access resources and so that the packets are taken from the queues and forwarded on to another link within network 20 and ultimately to another station. Such devices are also sometimes referred to as nodes. In an example where network 20 is an internet protocol (“IP”) network such as the global Internet or other IP-using network, then each packet transfer device is typically referred to as a router or a switch. However, one skilled in the art should appreciate that the use of the IP protocol is by way of illustration, and many of the various inventive teachings herein may apply to numerous other protocols and packet transfer devices. In any event, returning to network 20 as an IP network, and also by way of an example, each station STₓ may be constructed and function as one of various different types of computing devices, all capable of communicating according to the IP protocol. Lastly and also by way of example, only four stations STₓ are shown so as to simplify the illustration and example, where in reality each such station may be proximate other stations (not shown) and at a geography located at a considerable distance from the other illustrated stations.

Continuing with FIG. 1, and in the example of an IP network, then each packet transfer device along the outer periphery of network 20 is shown as one of edge routers ER₁ through ER₁₁, while within network 20 each packet transfer device is shown as one of core routers CR₁ through CR₄. The terms edge router and core router are known in the art and generally relate to the function and relative network location of a router. Typically, edge routers connect to remotely located networks and handle considerably less traffic than core routers. In addition and due in part to the relative amount of traffic handled by core routers, they tend to perform less complex operations on data and instead serve primarily a switching function; in other words, because of the tremendous amount of throughput expected of the core routers, they are typically hardware bound as switching machines and not given the capability to provide operations based on the specific data passing through the router. Indeed, core routers typically do not include much in the way of control mechanisms as there could be 10,000 or more connections in a single trunk. In contrast, edge routers are able to monitor various parameters within data packets encountered by the respective router. In any event, the various routers in FIG. 1 are shown merely by way of example, where one skilled in the art will recognize that a typical network may include quite a different number of both types of routers. Finally, note that each core router CRₓ and each edge router ERₓ may be constructed and function according to the art, with the exception that preferably those routers include additional functionality for purposes of traffic routing based on quality of service as considered in packet effective bandwidth, arrival variance, and mean, as described later.

Completing the discussion of FIG. 1, note that the various stations, edge routers, and core routers therein are shown connected to one another in various fashions and also by way of example. Generally characterizing the connections of FIG. 1, note that each station STₓ is shown connected to a single edge router ERₓ, where that edge router ERₓ is connected to one or more core routers CRₓ. The core routers CRₓ, also by way of example, are shown connected to multiple ones of the other core routers CRₓ. By way of reference, the following Table 1 identifies each node (i.e., station or router) shown in FIG. 1 as well as the other device(s) to which each is connected.

TABLE 1

| station or router | connected nodes |
|---|---|
| ST₁ | ER₁ |
| ST₂ | ER₁₀ |
| ST₃ | ER₅ |
| ST₄ | ER₇ |
| ER₁ | ST₁; CR₁ |
| ER₂ | CR₁; CR₂ |
| ER₃ | CR₂ |
| ER₄ | CR₂ |
| ER₅ | ST₃; CR₂; CR₃ |
| ER₆ | CR₃; CR₄ |
| ER₇ | ST₄; CR₄ |
| ER₈ | CR₄ |
| ER₉ | CR₄ |
| ER₁₀ | ST₂; CR₁ |
| ER₁₁ | CR₁ |
| CR₁ | ER₁; ER₂; ER₁₁; ER₁₀; ER₂; |
| | CR₂; CR₃; CR₄ |
| CR₂ | ER₂; ER₃; ER₄; CR₁; CR₃; |
| | CR₄; ER₅ |
| CR₃ | ER₅; ER₆; CR₂; CR₁; CR₄ |
| CR₄ | ER₇; ER₈; ER₉; CR₁; CR₂; |
| | CR₃; ER₆ |

Given the various connections as also set forth in Table 1, in general IP packets flow along the various illustrated paths of network 20, and in groups or in their entirety such packets are often referred to as network traffic. In this regard and as developed below, the preferred embodiments operate such that each router may schedule which packets from the router are transmitted at a given time, in accordance with QoS as well as other considerations.

FIG. 2 illustrates a functional block diagram of certain of the functionality in each router Rₓ of FIG. 1, that is, FIG. 2 may be preferably implemented in either or both of edge routers ERₓ and core routers CRₓ of FIG. 1. Note also that the illustration of FIG. 2 includes only those blocks deemed helpful in discussing the preferred embodiments, with the further understanding that additional functionally may be applied to any of routers Rₓ so as to support other known or developed functions provided by a router. Turning then to FIG. 2, router Rₓ includes an input R_{IN} along which packets are received from network 20, where input R_{IN} thereby represents the physical link connection to the network as well as any associated logical aspects, such as ports or the like. A packet received at input RIN is coupled to an input 30_{IN} of a flow determiner 30. An output 30_{OUT} of flow determiner 30 is connected to provide a received packet to any one of a number n+1 packet queues 320 through 32n. In a preferred embodiment, each queue 32ₓ is a first-in-first-out device and may be constructed according to known principles. The output of each queue 32ₓ is logically connected to provide each packet to two respective blocks; in practice, the physical connection in this regard may be made by providing a copy of each packet that is input to a queue 32ₓ also to the two blocks now described, where providing packet copies in this manner allows the true data link through a queue and to the ultimate router output, R_{OUT}, to remain undisturbed so that such traffic may be forwarded directly to a switching matrix (not shown). Looking then to the logical connection of packets from each queue 32ₓ to two respective blocks, first, the queue output is logically connected to an effective bandwidth (“Eb”) estimator 34ₓ, which estimates a value, Eb, and which as detailed below also produces a corresponding preliminary weight PWₓ. Second, the queue output is logically connected to an index dispersion for counts (“IDC”) determiner 36ₓ, which determines a corresponding value IDCₓ. The outputs, PWₓ and IDCₓ, of each pairing of an Eb estimator 34ₓ and IDC determiner 36ₓ are connected to a scheduler 38, which represents a logical control function for purposes of scheduling packet service in the various queues 32₀ through 32ₙ as appreciated in the remainder of this document. Further, and for reasons more clear below, within scheduler 38, the outputs, PWₓ and IDCₓ, of each pairing of an Eb estimator 34ₓ and IDC determiner 36ₓ are connected to a respective multiplier 40ₓ. The product produced by each of multipliers 40₀ through 40ₙ is connected to a weight optimizer 42, as is the value of each preliminary weight PWₓ. As detailed later, weight optimizer 42 represents a potential adjustment to any of the preliminary weights PW₀ through PWₙ to determine final respective weights W₀ through Wₙ. These final weights are then used to schedule the priority of packet service for the packets in queues 32₀ through 32ₙ; in other words, weight W₀ is associated with determining when the packets in queue 32₀ are transmitted, weight W₁ is associated with determining when the packets in queue 32₁ are transmitted, and so forth through Wₙ being associated with determining when the packets in queue 32ₙ are transmitted, where each of the transmissions are thus taken from the output of a respective queue 32ₓ to output R_{OUT} of router Rₓ. Note also that each weight Wₓ may be said to be associated with a so-called service grant for the respective queue 32ₓ, where such a grant thereby includes priority, scheduled time, or resources associated with the queue, depending on a specific implementation.

The operation of router Rₓ is now described, beginning with flow determiner 30. Flow determiner 30 receives each incoming packet and determines, from a set of criteria, to which one of multiple different flows the packet belong. Further, for each packet that satisfies a same criterion or criteria, it is routed by flow determiner to a corresponding one of queues 32₀ through 32ₙ. As a result, each queue 32ₓ stores packets of a same flow. The criteria evaluated by flow determiner 30 may be based on various different considerations. For example, the criteria may be based on the source and destination address included in the packet. For example with reference to FIG. 1, consider the case of core router CR₁ as a router Rₓ in FIG. 2, and consider further that flow determiner 30 of core router CR₁ has three sets of source/destination addresses corresponding to three different respective queues 32₀, 32₁, and 32₂. Also in this example, assume that the first set of source/destination addresses is from station ST₁ to station ST₂, the second set of source/destination addresses is from station ST₁ to station ST₃, and the third set of source/destination addresses is from station ST₁ to station ST₄. Thus, when flow determiner 30 of core router CR₁ receives a packet with a source address of ST₁ and a destination address of ST₂, then flow determiner 30 causes that packet to be stored in queue 32₀. Also therefore in this example, when flow determiner 30 of core router CR₁ receives a packet with a source address of ST₁ and a destination address of ST₃, then flow determiner 30 causes that packet to be stored in queue 32₁. Finally, when flow determiner 30 of core router CR₁ receives a packet with a source address of ST₁ and a destination address of ST₄, then flow determiner 30 causes that packet to be stored in queue 322. Note that source and destination addresses are only provided by way of example, where in the preferred embodiment the criteria may be directed to other aspects set forth in the packet header, including by ways of example the protocol field, type of service (“TOS”) field, or source/destination port numbers. Moreover, packet attributes about each packet other than that specified in the packet header also may be considered by flow determiner 30. For example, the physical input ports or interfaces connected to other routers may be used by flow determiner 30 as the criteria. In this case and as an instance of this example with reference also to FIG. 1, when flow determiner 30 of core router CR₁ receives a packet from edge router ER₁, then flow determiner 30 could cause that packet to be stored in queue 320, whereas also in this example, when flow determiner 30 of core router CR₁ receives a packet from edge router ER₂, then flow determiner 30 could cause that packet to be stored in queue 32₁.

As a packet is received in a queue 32ₓ, certain attributes of the packet are also available to the respective Eb estimator 34ₓ and IDC determiner 36ₓ. From these attributes, Eb estimator 34ₓ estimates the effective bandwidth, Eb, for the packet and IDC determiner 36ₓ determines the value of IDC for the packet. The determination of each of these values is discussed below.

Looking now in greater detail to Eb estimator 34ₓ and its estimation of effective bandwidth, Eb, the effective bandwidth for a traffic stream is the minimum bandwidth required for carrying that traffic, subject to meeting QoS requirements. In this regard, and in the context of FIG. 2, as a packet arrives its QoS, or the QoS associated with its respective queue 32ₓ, is available to the respective Eb estimator 34ₓ. Note that in some instances, the QoS requirements of the traffic are reduced to the condition that a given queue overflow probability not be exceeded. Further, in making these adjustments to QoS, statistical properties of the traffic stream are preferably considered as well as system parameters (e.g., queue size and service discipline) and the traffic mix. Lastly, note that the terms of equivalent bandwidth or equivalent capacity are often used as synonyms for effective bandwidth.

Given the preceding, a mathematical framework for determining a value of effective bandwidth, Eb, has been defined based on the general expression shown in the following Equation 1, and is noteworthy here insofar as it provides an understanding of the functionality provided by each Eb estimator 32ₓ in FIG. 2:

$$Eb ( s , t ) = \frac{1}{st} \cdot log E [ {ⅇ}^{( s \cdot {A}_{t} )} ] \qquad Equation 1$$

In Equation 1, the effective bandwidth is shown as Eb (s,t) to reflect the fact that it relates to variables s and t. In this regard, Aₜ is the amount of incoming work in duration of t. The values of (s, t) are the so-called space and time parameters, respectively, which characterize the operating point at the router link and depend on the context of the stream (i.e., link resources and the characteristics of the multiplexed traffic). The space parameter s shows the degree of statistical traffic multiplexing or “mix” of the link and the degree of QoS requirements. In this regard, often s tends toward infinity, which corresponds to the case of deterministic multiplexing (i.e., zero probability of overflow), but that case cannot be assumed. If QoS requirements are relaxed, or if the degree of multiplexing increases, s tends to zero and the effective bandwidth, Eb, approaches the mean rate. If QoS requirements are more constrained, or if the degree of multiplexing decreases, s tends to infinity and effective bandwidth, Eb, of the source approaches the maximum rate of max(Aₜ)/t, measured over the interval t. Note also that the time parameter t corresponds to the most probable duration of buffer busy period prior to overflow.

The effective bandwidth for various types of traffic models has been derived from the relationship set forth in Equation 1, where examples of such models appear in the following papers, all of which are hereby incorporated herein by reference: (1) C. Courcoubetis and R. Weber, “Buffer overflow asymptotics for a buffer handling many traffic sources,” J. Appl. Prob., vol. 33, pp. 886-903, 1996; (2) G. Kesidis, J. Walrand, and C. S. Chang, “Effective bandwidths for multiclass markov fluids and other ATM sources,” IEEE Trans. Network, vol. 1, no. 4, pp. 424-428, August 1993; (3) C. Courcoubetis, V. A. Siris, and G. Stamoulis, “Application of the many sources asymptotic and effective bandwidths to traffic engineering,” Telecommunication Systems, vol. 12, no. 2-3, pp. 167-191, 1999; and (4) R. Gibbens and P. Hunt, “Effective bandwidths for the multi-type uas channel,” Queuing Systems, vol. 9, pp. 17-28, 1991. However, unlike the estimation of observable parameters such as mean and variance, the space parameter s parameter cannot be directly estimated from measurements. Accordingly, some effective bandwidths algorithms calculate the space parameter s by using Large Deviations Theory (“LDT”) and by making a large buffer assumption. LDT deals with rare event probabilities and is suitably applied to the effective bandwidth determination since loss probability constraints to be satisfied are very small.

Note further that other manners exist in the art for estimating effective bandwidth, and those also may be implemented in connection with the preferred embodiment. For example, with space and time parameter estimation being a possible difficulty in the previously mentioned algorithms, Norros suggested a different approach to estimate effective bandwidth. This approach does not rely on large deviation theory and it addresses long-range dependent traffic type. This approach is based on the queue analysis of a server with Fractional Brownian Motion (“FBM”) input traffic. The main issue in this method is the FBM parameter estimation. The robust and feasible wavelet based H estimator suits in this method, where “H” is the Hurst parameter, a parameter used to measure the degree of self-similarity behavior on the underlying traffic. In any event, effective bandwidth estimation may be implemented from the above discussion as well as other alternatives and information ascertainable by one skilled in the art.

As introduced earlier, once an Eb estimator 34ₓ determines a value for effective bandwidth, Ebₓ, then the estimator 34ₓ also determines a respective preliminary weight, PWₓ. More particularly, in the preferred embodiment, for a determined value of effective bandwidth, Ebₓ, its respective preliminary weight, PWₓ, is as shown in the following Equation 2:

$${PW}_{x} = \frac{{EB}_{x}}{B} \qquad Equation 2$$

In Equation 3, B is the total bandwidth available to the router Rₓ. Thus, the preliminary weight is the ratio of effective bandwidth to total bandwidth. However, in the preferred embodiment and as detailed further below, from each preliminary weight a final and respective weight, Wₓ, is determined by weight optimizer 42, and the value of Wₓ may be adjusted upward above with respect to the respective value PWₓ based on two additional consideration, detailed later.

Looking now in greater detail to IDC determiner 36ₓ and its determination of a corresponding value IDCₓ, as each packet arrives in a queue 32ₓ, sufficient packet arrival time corresponding to that packet are stored by the respective IDC determiner 36ₓ so as to determine the respective value, IDCₓ. Particularly, the IDC has heretofore been proposed to be used to characterize packet burstiness in an effort to model Internet traffic, whereas in contrast, in the present inventive scope IDC is instead combined with the other attributes described herein to apply weights to packet queues for purposes of scheduling traffic. By way of background, in the prior art, in a document entitled “Characterizing The Variability of Arrival Processes with Index Of Dispersion,” (IEEE, Vol. 9, No. 2, February 1991) by Riccardo Gusella and hereby incorporated herein by reference, there is discussion of using the IDC, which provides a measure of burstiness, so that a model may be described for Internet traffic. Currently in the art, there is much debate about identifying the type of model, whether existing or newly-developed, which will adequately describe Internet traffic. In the referenced document, IDC, as a measure of burstiness, is suggested for use in creating such a model. IDC is defined as the variance of the number of packet arrivals in an interval of length t divided by the mean number of packet arrivals in t. For example, assume that a given network router has an anticipation (i.e., a baseline) of receiving 20 packets per second (“pps”), and assume further that in five consecutive seconds this router receives 30 packets in second 1, 10 packets in second 2, 30 packets in second 3, 15 packets in second 4, and 15 packets in second 5. Thus, over the five seconds, the router receives 100 packets; on average, therefore, the router receives 20 packets per second, that is, the average receipt per second equals the anticipated baseline of 20 pps. However, for each individual second, there is a non-zero variance in the amount of packets received from the anticipated value of 20 pps. For example, in second 1, the variance is +10, in second 2 the variance is −10, and so forth. As such, the IDC provides a measure that reflects this variance, in the form of a ratio compared to its mean, and due to the considerable fluctuation of the receiving rate per second over the five second interval, there is perceived to be considerable burstiness in the received packets, where the prior art describes an attempt to compile a model of this burstiness so as to model Internet traffic.

Also in connection with IDC, note that the interval, t, for the present discussion of IDC may be different from the time parameter, t, discussed above for effective bandwidth Eb, and they are not necessarily related. There are various prior art papers that attempt to identify an optimal “t” in Eb in the real cases. However, in a preferred embodiment, it may be desirable to align the time interval, t, of IDC with the time parameter, t, of effective bandwidth since scheduling is based on both Eb and IDC, although this is not necessarily the case. For example, the time parameter, t, in Eb can be specified as 2 seconds and the time interval, t, in IDC may be 10 seconds; alternatively, both times can be the same as well if the time scale works in both Eb and IDC.

Continuing with an examination of IDC determiner 36ₓ, attention is now directed to its actual operation in determining the IDC value for a given packet. Recalling that the IDC is defined as the variance of the number of packet arrivals in an interval of length t divided by the mean number of packet arrivals in t, it may be written as shown in the following Equation 3:

$${IDC}_{t} = \frac{var ( {N}_{t} )}{E ( {N}_{t} )} \qquad Equation 3$$

In Equation 3, Nₜ indicates the number of arrivals in an interval of length t. In the preferred embodiment and for estimating the IDC of measured arrival processes, only considered are the time at discrete, equally spaced instants τᵢ (i≧0). Further, letting cᵢ indicate the number of arrivals in the time interval τᵢ−τᵢ₋₁, then the following Equation 4 may be stated:

$${IDC}_{n} = \frac{var ( {\sum }_{i = 1}^{n} {c}_{i} )}{E ( {\sum }_{i = 1}^{n} {c}_{i} )} \\ = \frac{var ( {c}_{1} + {c}_{2} + ⋯ + {c}_{n} )}{E ( {c}_{1} + {c}_{2} + ⋯ + {c}_{n} )} \\ = \frac{n \cdot var ( {c}_{τ} ) + 2 {\sum }_{j = 1}^{n - 1} {\sum }_{k = 1}^{n - j} cov ( {c}_{j} , {c}_{j + k} )}{n \cdot E ( {c}_{τ} )} \qquad Equation 4$$

In Equation 4, var(c_{τ}) and E(c_{τ}) are the common variance and mean of cᵢ, respectively, thereby assuming implicitly that the processes under consideration are at least weakly stationary, that is, that their first and second moments are time invariant, and that the auto-covariance series depends only on the distance k, the lag, between samples: cov(cᵢ, cᵢ₊ₖ)=cov (cⱼ, Cⱼ₊ₖ), for all i, j, and k.

Further in view of Equations 3 and 4, consider the following Equation 5:

$${\sum }_{j = 1}^{n - 1} {\sum }_{k = 1}^{n - j} cov ( {c}_{j} , {c}_{j + k} ) = \text{sum of} \{ \begin{matrix}j = 1 , & cov ( 1 ) + cov ( 2 ) + ⋯ + cov ( n - 2 ) + cov ( n - 1 ) \\ j = 2 , & cov ( 1 ) + cov ( 2 ) + ⋯ + cov ( n - 2 ) \\ ⋮ & ⋮ \\ j = n - 2 , & cov ( 1 ) + cov ( 2 ) \\ j = n - 1 , & cov ( 1 )\end{matrix} = {\sum }_{j = 1}^{n - 1} ( n - j ) cov ( j ) \qquad Equation 5$$

Further, for the auto-correlation coefficient ξ_{i,j+k}, it may be stated as in the following Equation 6:

$${ξ}_{i , i + k} = {ξ}_{k} = \frac{cov ( {c}_{i} , {c}_{i + k} )}{\sqrt{var ( {c}_{i} )} \sqrt{var ( {c}_{i + k} )}} = \frac{cov ( k )}{cov ( {c}_{τ} )} \qquad Equation 6$$

Then from Equation 6, the following Equation 7 may be written:

$${I}_{n} = \frac{n \cdot var ( {c}_{τ} ) + 2 {\sum }_{j = 1}^{n - 1} {\sum }_{k = 1}^{n - j} cov ( {c}_{j} , {c}_{j + k} )}{n \cdot E ( {c}_{τ} )} \\ = \frac{var ( {c}_{τ} )}{E ( {c}_{τ} )} [ 1 + 2 {\sum }_{j = 1}^{n - 1} \frac{n - j}{n} {ξ}_{j} ] \\ = \frac{var ( {c}_{τ} )}{E ( {c}_{τ} )} [ 1 + 2 {\sum }_{j = 1}^{n - 1} ( 1 - \frac{j}{n} ) {ξ}_{j} ] by using cov ( k ) \\ = {ξ}_{k} \cdot var ( {c}_{τ} ) \qquad Equation 7$$

Finally, therefore, the unbiased estimate of E(c_{τ}), var(c_{τ}), and ξⱼ are as shown in the following respective Equations 8 through 10:

$$\begin{matrix}E ( {c}_{τ} ) = \frac{1}{n} {\sum }_{i = 1}^{n} {c}_{i} & Equation 8 \\ var ( {c}_{τ} ) = \frac{1}{n - 1} {\sum }_{i = 1}^{n} {( {c}_{i} - E ( {c}_{τ} ) )}^{2} & Equation 9 \\ {ξ}_{j} = \frac{cov ( j )}{var ( {c}_{τ} )} = \frac{\frac{1}{n - j} {\sum }_{i = 1}^{n - j} ( {c}_{i} - E ( {c}_{τ} ) ) ( {c}_{i + j} - E ( {c}_{τ} ) )}{var ( {c}_{τ} )} & Equation 10\end{matrix}$$

Thus, the IDC may be determined by the preferred embodiment using the above Equations 8 and 9, and further in view of Equation 10.

Having demonstrated various alternatives for preferred embodiment determination of the preliminary weight PWₓ and the respective value of IDCₓ, recall that each of these values provides a multiplicand into a respective multiplier 40ₓ, with the product output being connected to weight optimizer 42, which also receives the value of each preliminary weight, PWₓ. Given these connections, in the preferred embodiment, weight optimizer 42 is operable to determine, for each preliminary weight, PWₓ, a corresponding final weight, Wₓ. Specifically, these corresponding final weights are determined from the constraints imposed by the following Equations 11, 12, and 13:

$$\begin{matrix}{W}_{x} \geq ( {PW}_{x} = \frac{{Eb}_{x}}{B} ) & Equation 11 \\ {\sum }_{x = 0}^{n} {W}_{x} = 1 & Equation 12 \\ min {\sum }_{x = 0}^{n} {W}_{x} * {IDC}_{x} & Equation 13\end{matrix}$$

Equation 11 demonstrates that for each preliminary weight value, PWₓ, its corresponding final weight value, Wₓ, is equal to or exceeds the preliminary weight value, PWₓ. Further, Equation 12 demonstrates that all final weight values combined should total a value of one. Lastly, Equation 13 solves an objective function, that is, each final weight value, Wₓ, is adjusted so that the summation of Equation 13 is minimized. This latter constraint therefore is such that by minimizing an objective function from the overall traffic burstiness, each value Wₓ is determined so as to fairly allocate the bandwidth weight to smooth the bursty traffic without compromising the QoS requirements. Given the final weight values {W₀, W₁, . . . , Wₙ}, weight optimizer 42 outputs those as part of scheduler 38, to control respective queues 32₀ through 32ₙ. In other words, each queue 32ₓ is then serviced in priority as defined by its corresponding final weight, Wₓ. Accordingly, scheduling of resource access and packet transmission is thereby weighted according to these values and, thus, this more fairly allocates bandwidth while smoothing burstiness and taking into consideration QoS requirements

From the above illustrations and description, one skilled in the art should appreciate that the preferred embodiments provide a computer network with routers or switches configured to schedule traffic according to a dynamic fair mechanism in response to quality of service and an index dispersion of counts. The embodiments provide numerous benefits over the prior art. As one example, as compared to static mechanisms, the preferred embodiments dynamically schedule link bandwidth based on real-time traffic measurements. In addition, unlike various dynamic algorithms, which simply allocate excess bandwidth according to the number of flows in a specific class of service or the pre-defined committed information rates, the preferred embodiment considers the actual on-line traffic burstiness, as measured in IDC, as an objective function. As still another example, the preferred embodiments also take advantage of effective bandwidth as the lower bound, which guarantees the QoS requirements for the high priority traffic flows or classes can be always satisfied during the optimization. As yet another benefit, in the preferred embodiments, excess bandwidth of a flow or a class of flows is not only reused by that flow or class but is allocated to other flows or classes as well. Further, by designating the lower bound for the flows having little QoS requirements such as Best-Effort traffic, these flows can also capture the least bandwidth so that the fairness for the excess bandwidth allocation can be achieved. Note that these preferred embodiments and benefits can be well applied in the DiffServ environment because in that context the classes of traffic flows are the primary targets instead of individual flows so that there are less scalability issues. As a final benefit, while the preferred embodiments have been described in connection with an IP network, they also may be applied to any network that is cell or packet based. Given the above, it will be further appreciated that while the present embodiments have been described in detail, various substitutions, modifications or alterations could be made to the descriptions set forth above without departing from the inventive scope which is defined by the following claims.

1. A network system, comprising:
a plurality of nodes;
wherein each node in the plurality of nodes is coupled to communicate with at least one other node in the plurality of nodes; and
wherein each node of the plurality of nodes comprises a plurality of queues and is operable to perform the steps of:
receiving a plurality of packets;
for each received packet in the plurality of packets, coupling the received packet into a selected queue in the plurality of queues, wherein a respective selected queue is selected in response to the respective received packet satisfying one or more criteria; and
assigning a weight to each respective queues in the plurality of queues, wherein each weight assigned to a respective queue in the plurality of queues is responsive to quality requirements for each packet in the respective queue and to a ratio of packet arrival variance in the respective queue and a mean of packets arriving to be stored in the respective queue during a time interval.

2. The system of claim 1 wherein, for each queue in the plurality of queues:
the weight assigned to the respective queue comprises a weight Wₓ;
the ratio for a respective queue comprises a value IDCₓ; and
wherein each weight in the plurality of weights is optimized in response to minimizing a sum of a product of each weight Wₓ with its respective value IDCₓ.

3. The system of claim 1 wherein each node of the plurality of nodes is further operable to perform the step of scheduling transmission of packets from each queue of the plurality of queues in response to a respective weight, from the plurality of weights, assigned to the queue.

4. The system of claim 1 wherein each received packet comprises an IP packet and wherein the quality requirements comprise QoS.

5. The system of claim 1:
wherein each packet in the plurality of packets comprises a respective packet header; and
wherein the one or more criteria are evaluated relative to information in the packet header.

6. The system of claim 5 wherein the one or more criteria are selected from a set consisting of source address, destination address, protocol field, type of service field, and source/destination port numbers.

7. The system of claim 5:
wherein each weight is responsive to quality requirements by responding to effective bandwidth Eb;
wherein Eb is defined as:
$$Eb = \frac{1}{st} \cdot log E [ {ⅇ}^{( s \cdot {A}_{t} )} ] ;$$
wherein Aₜ is an amount of incoming work in duration of t; and
wherein (s, t) are space and time parameters, respectively, which characterize an operating point at a link to the node.

8. The system of claim 1:
wherein each weight is responsive to quality requirements by responding to effective bandwidth Eb;
wherein Eb is defined as:
$$Eb = \frac{1}{st} \cdot log E [ {ⅇ}^{( s \cdot {A}_{t} )} ] ;$$
wherein Aₜ is an amount of incoming work in duration of t; and
wherein (s, t) are space and time parameters, respectively, which characterize an operating point at a link to the node.

9. The system of claim 1 wherein the network comprises an internet protocol network.

10. The system of claim 1 wherein the internet protocol network comprises the global internet.

11. The system of claim 1 wherein each node of the plurality of nodes is selected from a set consisting of a router and a switch.

12. The system of claim 1 wherein each node of the plurality of nodes is selected from a set consisting of an edge router and a core router.

13. The system of claim 1 wherein, for each queue in the plurality of queues:
the weight assigned to the respective queue comprises a weight Wₓ;
the ratio for a respective queue comprises a value IDCₓ; and
wherein each weight in the plurality of weights is optimized in response to minimizing a sum of a product of each weight Wₓ with its respective value IDCₓ; and
wherein each node of the plurality of nodes is further operable to perform the step of scheduling transmission of packets from each queue of the plurality of queues in response to a respective weight, from the plurality of weights, assigned to the queue.

14. The system of claim 13:
wherein each weight is responsive to quality requirements by responding to effective bandwidth Eb;
wherein Eb is defined as:
$$Eb = \frac{1}{st} \cdot log E [ {ⅇ}^{( s \cdot {A}_{t} )} ] ;$$
wherein Aₜ is an amount of incoming work in duration of t; and
wherein (s, t) are space and time parameters, respectively, which characterize an operating point at a link to the node.

15. The system of claim 14:
wherein each weight responds to the effective bandwidth Eb by being greater than or equal to a ratio of the effective bandwidth Eb to a total bandwidth available to the node; and
wherein a total for all weights for all queues in the plurality of queues equals one.

16. A method of operating a node in a plurality of nodes in a network system, wherein each node in the plurality of nodes is coupled to communicate with at least one other node in the plurality of nodes, the method comprising:
receiving a plurality of packets;
for each received packet in the plurality of packets, coupling the received packet into a selected queue in a plurality of queues in the node, wherein a respective selected queue is selected in response to the respective received packet satisfying one or more criteria; and
assigning a weight to each respective queues in the plurality of queues, wherein each weight assigned to a respective queue in the plurality of queues is responsive to quality requirements for each packet in the respective queue and to a ratio of packet arrival variance in the respective queue and a mean of packets arriving to be stored in the respective queue during a time interval.

17. The method of claim 16 wherein, for the assigning step:
the weight assigned to the respective queue comprises a weight Wₓ;
the ratio for a respective queue comprises a value IDCₓ; and
wherein each weight in the plurality of weights is optimized in response to minimizing a sum of a product of each weight Wₓ with its respective value IDCₓ.

18. The method of claim 16 and further comprising the step of scheduling transmission of packets from each queue of the plurality of queues in response to a respective weight, from the plurality of weights, assigned to the queue.

19. The method of claim 16 wherein each received packet comprises an IP packet and wherein the quality requirements comprise QoS.

20. The method of claim 19:
wherein each weight is responsive to quality requirements by responding to effective bandwidth Eb;
wherein Eb is defined as:
$$Eb = \frac{1}{st} \cdot log E [ {ⅇ}^{( s \cdot {A}_{t} )} ] ;$$
wherein Aₜ is an amount of incoming work in duration of t; and
wherein (s, t) are space and time parameters, respectively, which characterize an operating point at a link to the node.

21. The method of claim 16:
wherein each weight is responsive to quality requirements by responding to effective bandwidth Eb;
wherein Eb is defined as:
$$Eb = \frac{1}{st} \cdot log E [ {ⅇ}^{( s \cdot {A}_{t} )} ] ;$$
wherein Aₜ is an amount of incoming work in duration of t; and
wherein (s, t) are space and time parameters, respectively, which characterize an operating point at a link to the node.

22. The method of claim 21:
wherein each weight responds to the effective bandwidth Eb by being greater than or equal to a ratio of the effective bandwidth Eb to a total bandwidth available to the node; and
wherein a total for all weights for all queues in the plurality of queues equals one.
